(19) United States
(12) Patent Application Publication
(10) Pub. No.: US 2010/0049352 A1
(43) Pub. Date: Feb. 25, 2010

(54) SYSTEM AND METHOD FOR AUTOMATICALLY PROCESSING AND/OR MACHINING WORKPIECES

(75) Inventors: Martin Kohlmaier, Medling (AT); Rainer Krappinger, Kaltenleuitgeben (AT)

Correspondence Address: DARBY & DARBY P.C., P.O. BOX 770, Church Street Station, New York, NY, 10008-0770, US

(73) Assignee: ABB AG, VIENNA (AT)

(21) Appl. No.: 12/446,388

(22) PCT Filed: Oct. 18, 2007
(86) PCT No.: PCT/EP07/09042

§ 371 Date: Apr. 20, 2009

(30) Foreign Application Priority Data
Oct. 19, 2006 (DE) 10 2006 049 956.5

(51) Int. Cl. B25J 9/12; G05B 13/02

(52) U.S. Cl. 700/103; 700/253; 901/50; 901/41; 901/9

(57) ABSTRACT

A system for automated processing of workpieces comprises at least one handling apparatus having at least one measuring arrangement configured to record at least one controlled variable and at least one regulatory device configured to interact with the at least one measuring arrangement to optimize the processing using the at least one control variable. The processing also includes machining, and the at least one handling apparatus includes a robot.

This is a U.S. National Phase Application under 35 U.S.C. §371 of International Application No. PCT/EP2007/009042, filed on Oct. 18, 2007, which claims priority to German Application No. DE 10 2006 049 956.5, filed on Oct. 19, 2006. The International Application was published in German on Apr. 24, 2008 as WO 2008/046619 A1 under PCT Article 21(2).

The invention relates to a system and a method for the automated machining and/or processing of workpieces, wherein at least one handling apparatus, particularly a robot and/or an industrially applicable robot, can be used to automatically perform a prescribable machining and/or processing process for at least one workpiece.

### BACKGROUND

Robots are performing more and more tasks and functions as part of industrial production. In this context, increased use is being made of robots in order to position and/or assemble components at a predetermined location, that is to say for assembly purposes, but also increasingly for the purpose of machining workpieces, such as for lacquering, grinding, laser-cutting, polishing, drilling, milling, and the like, with appropriate robot tools being equipped with the relevant machining tools, such as welding heads, lacquering nozzles or laser-cutting apparatuses. In this case, the robots perform preprogrammed movements with the axes provided. To achieve at least uniform machining quality, particularly for surface machining, it is necessary to stabilize and/or inspect the contact forces between the workpiece to be machined and the tool used for the machining. For this, industry conventionally involves the use of different systems. When grinding a workpiece, for example, compressed air can be used to apply a predetermined contact pressure from the grinding tool to the workpiece to be ground, in order to ensure continual contact between the workpiece and the tool in the machining or production process and to avoid a loss of contact and hence losses of or dips in grinding quality. Other systems comprise mechanical suspension, suspension by means of rubber blocks, electromagnetic suspension with essentially comparable modes of operation and/or similar operating principles, for example. Drawbacks have to date not allowed known systems and/or methods to regulate and/or adjust the applied contact forces with sufficient accuracy and/or speed, particularly when using compressed air, which means that it has not been possible to date to regulate a predeterminable or presettable machining force or contact force to a constant value during the machining process.

Particularly in the case of compressed air, this can be at least proportionally attributed to the compressibility thereof, since this means that it is not possible to ensure an airstream which is constant in volume and speed. Further restrictions are experienced by the known systems particularly also as a result of physical laws in the process handling. Thus, when compressed air is used, the achievable contact forces are limited by the performance of the pressure supply (mains system and compressor). When electrical systems are used, for example when electromagnets are used, comparatively large currents and/or voltages are required in order to overcome the existing resistances and generate the necessary field strengths. The electromagnetic compatibility of the other process components also plays a part in this context. In addition, the contact forces which can be applied are also limited by the physical shape, the design and the specific material properties of the tools used and also of the workpieces to be machined, and substantial differences can arise locally, for example in a transition from a thick-walled to a thin-walled region of the workpiece and/or when different materials are used with different specific properties, such as surface hardness. With an accordingly comparatively complex process structure, the design-dependent flexibility of the handling appliances may also be drastically restricted, and restricted compensation mechanisms may result for the tools as a result of limitations on travel. This may in turn result in automated systems being unable to compensate for varying dimensional accuracy in the components. Further correction or adjustment of the applied contact forces may also be required when tool wear occurs, for example. Such automated adjustment has also not been adequately possible to date using known systems and methods, which means that the underlying machine processes can often be implemented only manually, ultimately resulting in natural deviations and/or differences in the machining arising and each machined component being given the nature of a unique item.

### SUMMARY OF THE INVENTION

Accordingly, an aspect of the present invention is to provide an improved way of achieving a reproducible and/or uniform machining quality during automated machining, particularly during surface machining, of a workpiece, particularly also under varying ambient conditions.

Advantageous embodiments and developments of the system according to the invention and an appropriate method for machining and/or processing workpieces are specified in the claims and in the description which follows.

The inventive system for the automated machining and/or processing of workpieces has at least one handling apparatus, particularly a robot or industrial robot, having at least one measuring arrangement for recording at least one controlled variable, wherein at least one regulatory device is provided which interacts with at least one measuring arrangement and takes account of the at least one controlled variable for the purpose of optimizing the respective machining and/or processing process.

In one advantageous embodiment of the system, the respective machining and/or processing process is optimized by means of controlled-variable-dependent correction of a prescribed motion sequence and hence by correcting the trajectory and/or position of the handling apparatus.

One development of the system provides for at least one holding apparatus, arranged at a distal end of the handling apparatus, for holding at least one tool or at least one workpiece.

The at least one tool which may be used in this case is, in particular, a grinding and/or polishing and/or milling and/or deburring tool.

The at least one workpiece which may be used in this case is, in particular, housing elements, for example camera housing parts, to be polished and/or to be ground and/or to be deburred. The housing elements may be formed from magnesium or aluminum or a combination thereof, for example.

In one embodiment of the system, at least one measuring arrangement is provided for the purpose of determining forces and/or moments and/or for the purpose of determining force and/or moment differences, wherein the controlled variable taken into account and/or utilized is the forces and/or moments acting in at least one predeterminable direction between the tool used and the respective workpiece.

In one system development, at least one control device is provided for the purpose of position and/or motion control of the handling apparatus, said device interacting with the at least one regulatory device such that the control device is sent control correction values, particularly motion and/or position correction values, corresponding to respectively performed position and/or trajectory optimization, for a prescribed motion sequence and/or trajectory profile for implementation.

The system may also have provision for the aforementioned measuring arrangement to be able to absolutely record, qualitatively, the forces and/or moments occurring or acting in at least one freely prescribable direction and/or along at least one axis between the tool and the workpiece and/or for the recorded measured values to be able to be transmitted to the regulatory component via at least one provideable interface for communication and data interchange.

In a further embodiment of the system, it is advantageously possible to provide for forces and/or moments, or force and/or moment deviations, occurring along at least one axis and/or in at least one prescribable direction to be recorded relative to at least one predetermined value and/or transmitted to the regulatory device via at least one provideable interface, particularly by wire, such as by means of USB, Ethernet, RS-232, Fire-Wire, SCSI or another LAN, or wirelessly, such as by means of Bluetooth, infrared, a radio link or another WLAN for communication and data interchange.

Advantageously, it is also possible to provide for the at least one direction to be freely definable in the space of a static and/or moving reference system or coordinate system, which allows optimized trajectory correction and, as a result, optimum use of a respective tool for machining the respective workpiece, even when there are a multiplicity of machining processes and/or even when the ambient parameters are variable.

In one advantageous embodiment of the system, the regulatory device interprets and processes the transmitted measured values of the respective controlled variable and/or, as a result, ascertains a respective motion or trajectory correction and/or corresponding trajectory correction value for the handling apparatus and/or effects appropriate trajectory and/or position optimization.

In particular, the at least one regulatory device interacts with the control device and the at least one measuring arrangement so that the force acting in at least one predeterminable direction and/or the moment acting in at least one direction is regulated to and/or kept constant at at least one predetermined reference value.

In one development of the system, the regulatory device is used to select a respectively suitable reference value from a predeterminable set of reference values, which are stored particularly on a data store so as to be able to be called, on the basis of one or more prescribable parameters, such as the current position of the tool or the workpiece, the type of tool used, the type of the respective machining or processing process.

Accordingly, provision may be made for the regulatory device to have a data store with stored reference values.

In one advantageous development of the system, the measured value recording and/or processing is effected cyclically or continuously by the measuring arrangement in interaction with the regulatory device, in which case the resultant trajectory and/or position correction or trajectory and/or position optimization is also effected cyclically or continuously.

Advantageously, the at least one handling apparatus is in single- or multiple-axis form, particularly six-axis form, which means that there are six possible degrees of rotation freedom.

In one advantageous development of the system, the at least one regulatory device is integrated in the control device and is part thereof.

In a further embodiment, the regulatory device is of modular design and/or can be integrated into the control device.

In particular, the control device and/or regulatory device and/or measuring arrangement have at least one respective interface for wired and/or wireless communication and/or for data interchange.

By way of example, these may be hardware interfaces between physical systems, such as PCI-bus, SCSI, USB, Firewire or else RS-232, and/or data interfaces for interprocess communication (IPC), particularly over a network, such as Remote Procedure Call, DCOM, RMI or CORBA, or else ODBC and JDBC. The known network protocol such as TCP, HTTP, etc. can also be understood to be IPC interfaces.

It is also advantageously possible to use the popular industrial and/or field bus systems and their interfaces for data interchange and/or data communication. These also include CAN-BUS, Profibus, field bus, MOST-bus, LIN-bus, EIB, KNX or else FlexRay, for example.

In another embodiment, the measuring arrangement comprises at least one force and/or moment sensor based on one of the principles/types cited below:
piezoelectric sensor; in a piezoelectric sensor, pressure, that is to say force per area, is used to produce an electrical voltage in a crystal, with electrical charges being isolated in the crystal (piezoelectric effect). In this case, the electrical voltage changes in a predetermined range in proportion to the force. This effect also works the other way around, so that applying an electrical voltage to the piezoelectric sensor causes the latter to deform. Furthermore, piezoelectric sensors afford several advantages, for example they are insensitive toward high temperatures, no external power supply is required and their efficiency is comparatively high.
force transducer; when force transducers are used, action of force causes a spring element to elastically deform, the force needing to be taken up in a prescribed direction. The deformation of the spring body, usually metal, which is brought about by the action of force is converted into electrical voltage by means of expansion measuring strips. An appropriately providable measurement amplifier, for example, is then used to register the electrical voltage brought about by the action of force and hence the expansion change, and/or said electrical voltage and hence expansion change can be converted into a force measured value on the basis of the elastic properties of the spring body.
differential pressure gauge; this measures the difference between two absolute pressures, what is known as the differential pressure. The differential pressure sensor may have two measuring chambers which are hermetically isolated from one another by a diaphragm. The measureable deflection in the diaphragm is then a measure of the size of the differential pressure. The chambers may be filled with liquid, particularly also with a gel of appropriate viscosity.

In one advantageous embodiment, at least one measuring arrangement for determining forces and/or moments or for determining force and/or moment differences is arranged in the region of at least one of the axes or axes of rotation of the handling apparatus.

The system may also have provision for at least one measuring arrangement to be in the form of part of the kinematics of the handling apparatus.

In one development of the system, the handling apparatus is in the form of a robot, particularly in the form of an industrially applicable robot, with at least one axis of rotation, but particularly six axes of rotation.

In one development of the system, the handling apparatus moves the respective tool relative to the workpiece along a predetermined trajectory.

Alternatively, provision may also be made for the handling apparatus to move the respective workpiece relative to the tool along a predetermined trajectory.

In addition, it is possible to provide for the measuring arrangement to allow forces and/or moments to be determined or force and/or moment differences to be determined in one or more axes, particularly six axes, and/or a resultant comprising a plurality of axes of the handling apparatus.

In one development of the system, the holding apparatus has a grinding and/or polishing machine and/or a miller and/or a deburring tool.

Advantageously, it is possible to provide for complex shapings and/or material transitions and/or different materials of the workpieces also to be taken into account or able to be taken into account and/or able to be implemented in the regulatory device.

In one advantageous embodiment of the system, further measuring arrangements are provided for recording further physical variables for the tool, workpiece and/or handling apparatus, for example.

In particular, it is possible to provide for the regulatory device to influence process variables indirectly and/or directly.

In another form of the system, a multiplicity of measuring arrangements of different form, function and design, such as force sensors, pressure sensors, distance gauges, motion sensors, speed sensors, position sensors, conductimeters, optical sensors and sensing elements, particularly for temperature and/or humidity, are used in interaction or separately from one another for recording measured values and/or forming measurement signals.

In one advantageous embodiment, the regulatory device also takes account of the use of additives supporting the respective machining process, such as the use of different grinding pastes for grinding and/or polishing, different granulations for grinding and/or polishing and/or sandblasting, through suitable parameter selection, wherein, by way of example, each additive has at least one appropriate process parameter associated with it, for example a specific reference value for the controlled variable, particularly the contact force between the grinder and the workpiece, but also the machining speed or speed of the handling apparatus, for example.

In one development of the system, the recorded measured values from the measuring arrangement are used for absolute or relative calibration of the handling apparatus.

Advantageously, the system may also have provision for one or more machining steps, including with different tools and/or ambient conditions or parameters, to be possible, with provision advantageously being able to be made for the change of tools and/or parameters and/or the parameter-specific reference value adjustment to be performed automatically.

In addition, it is advantageously possible to provide for different orientations of the respective machining or processing tool, for example requisite oblique application of the grinder to the respective workpiece, which forms an angle between the normal to the surface of the workpiece and the axis of rotation of the grinder, to be able to be taken into account and/or to have no influence on the manner of operation of the measuring arrangement and/or the regulatory device.

In one advantageous embodiment of the system, the manner of operation of the measuring arrangement and/or of the regulatory device is independent of the relative motion and/or relative speed between the tool and the workpiece.

Advantageously, the use of the measuring arrangement and/or regulatory device and the optimization process does not adversely affect the manner of operation and flexibility of the handling apparatus and/or any supply lines.

By taking into account a measureable controlled variable, the abovementioned system thus allows a reproducible and/or uniform machining quality to be achieved, particularly during surface machining, even with changing ambient parameters, for example different grinding pastes and, as a result, different contact forces during different grinding and/or polishing operations.

The present invention also provides an appropriate method for the automated machining and/or processing of workpieces, wherein at least one measuring arrangement of a handling apparatus is used to record at least one controlled variable, and at least one regulatory device is used to optimize the respective machining and/or processing process by taking account of the at least one controlled variable.

In one embodiment of the method, the respective machining and/or processing process is optimized by taking the ascertained controlled variable as a basis for correcting a prescribed, particularly programmed, motion sequence and hence correcting the trajectory and/or position of the handling apparatus.

The machining and/or processing processes applied in this context are particularly grinding and/or polishing and/or milling and/or deburring processes, and, on that basis, appropriate tools, particularly grinding machines, polishing machines, millers and/or deburrers, are also used.

In one development of the method, at least one measuring arrangement is used to determine forces and/or moments and/or to determine force and/or moment differences, wherein the controlled variable taken into account is the forces and/or moments acting in at least one predeterminable direction between the respective tool used and the respective workpiece.

Advantageously, it is also possible to provide for the at least one direction to be able to be defined freely in the space of a static and/or a moving reference system or coordinate system, which allows optimized trajectory correction and, as a result, optimum use of a respective tool for machining the respective workpiece, even when there are a multiplicity of different kinds of machining processes and/or even when ambient conditions or parameters are variable.

In a further embodiment of the method, the recorded controlled-variable measured values are used to ascertain appropriate control correction values, particularly motion and/or position correction values, and to transmit them to a control device for the handling apparatus in order to perform appropriate position and/or trajectory optimization for implementation.

The method may also have provision for the aforementioned measuring arrangement to absolutely record, in particular qualitatively, the forces and/or moments occurring and/or acting in at least one freely prescribable direction and/or along at least one axis between the tool and the workpiece and/or to transmit the recorded measured values to the regulatory device, for example via at least one provideable interface for communication and data interchange.

In another embodiment of the method, provision may advantageously be made for forces and/or moments, or force and/or moment deviations, occurring along at least one axis and/or in at least one prescribable direction to be recorded relative to at least one predetermined reference value and/or to be transmitted to the regulatory device via at least one prescribable interface, in particular by wire, for example by means of USB, Ethernet, RS-232, Firewire, SCSI or another LAN, or wirelessly, for example by means of Bluetooth, infrared, a radio link or another WLAN for communication and for data interchange.

In one advantageous embodiment of the method, the at least one regulatory device is used to interpret and process the transmitted measured values of the respective controlled variable and/or, as a result, to ascertain a respective motion or trajectory correction and/or corresponding trajectory correction value for the handling apparatus and/or to effect appropriate trajectory and/or position optimization.

In particular, the force acting in at least one predeterminable direction and/or the moment acting in at least one direction is regulated to and/or kept constant at at least one predetermined reference value.

In another embodiment of the method, one or more prescribable parameters, such as the current position of the tool or the workpiece, the type of tool used, the type of the respective machining or processing process, is/are taken as a basis for selecting a respectively suitable reference value from a predeterminable set of reference values which can be stored particularly on a data store so as to be able to be called.

In one advantageous development of the method, the measured value recording and/or processing is performed cyclically or continuously, in which case the resultant trajectory and/or position correction or trajectory and/or position optimization is also performed cyclically or continuously.

Advantageously, the method may have provision for, in particular, six possible degrees of rotational freedom of the handling apparatus to be taken into account.

In one advantageous development of the method, the communication and/or the data interchange, particularly when the recorded measured values and/or the position and/or trajectory correction values are transmitted, can each be effected by wire or wirelessly using suitable interfaces.

By way of example, these may be hardware interfaces between physical systems, such as PCI-bus, SCSI, USB, Firewire or else RS-232, and/or data interfaces for interprocess communication (IPC), particularly over a network, such as Remote Procedure Call, DCOM, RMI or CORBA, or else ODBC and JDBC. The known network protocols such as TCP, HTTP, etc. can also be understood to be IPC interfaces.

Popular industrial and/or field bus systems and their interfaces can also advantageously be used for data interchange and/or data communication. By way of example, these also include CAN-BUS, Profibus, field bus, MOST-bus, LIN-bus, EIB, KNX or else FlexRay.

In another embodiment, the method involves the use of at least one piezoelectric sensor and/or a force transducer and/or a differential pressure gauge as a force and/or moment sensor.

The method may also have provision for the at least one handling apparatus to be used to move the respective processing or machining tool relative to the workpiece along a predetermined, in particular programmed, trajectory or alternatively to move the respective workpiece relative to the tool along a predetermined, in particular programmed trajectory.

In one variant embodiment, the measuring arrangement is used to determine forces and/or moments or to determine force and/or moment differences in one or more axes, particularly six axes, and/or a resultant, comprising a plurality of axes, of the handling apparatus.

It is advantageously possible to provide for complex shapings and/or material transitions and/or different materials of the workpieces also to be taken into account in line with the method.

Provision may also be made for further physical and/or process-related variables, particularly for the tool, workpiece and/or handling apparatus, to be recorded.

In one variant embodiment, a plurality of measuring arrangements of different form, function and/or design, for example force sensors, pressure sensors, distance gauges, motion sensors, speed sensors, position sensors, conductimeters, optical sensors and sensing elements are used, particularly for temperature and/or humidity, in interaction or separately from one another, for recording one or more controlled variables and the respective measured values and/or the resultant measurement signal.

In one advantageous form of the method, account is also taken of use of the respective parameter selection, wherein, by way of example, each additive supporting the machining process, such as different grinding pastes for grinding and/or polishing, different granulations for grinding and/or polishing and/or sandblasting, is assigned at least one further process parameter, for example a specific reference value for the respective controlled variable, particularly the contact force between the grinder and the workpiece, but also the machining speed or speed of the handling apparatus, for example, on a characteristic-specific and/or parameter-specific basis through suitable combination.

In one development of the method, the recorded measured values from the measuring arrangement are also used for calibrating the handling apparatus.

Advantageously, the method may also involve one or more machining steps, including with different tools and/or under different ambient conditions or parameters, being processed, it being advantageously possible to provide for a change of tools and/or a parameters and/or a parameter-specific reference value adjustment to be performed automatically.

It is also advantageously possible to provide for different orientations of the respective machining or processing tool, for example requisite oblique application of the grinder to the respective workpiece, which forms an angle between the normal to the surface of the workpiece and the axis of rotation of the grinder, to be able to be taken into account and/or to have no influence on the method sequence or the performance of the method.

In one variant embodiment, the type of trajectory optimization, or the underlying process parameters, is/are selected under program control using at least one predeterminable characteristic.

One embodiment of the method also provides for one or more prescribable characteristics, such as the current position of the tool or the workpiece, the type of tool used, the type of the respective machining or processing process, to be taken as a basis for selecting a respectively suitable reference value from a predeterminable set of reference values which may be stored on a data store, in particular, so as to be able to be called.

It is also advantageously possible to provide for the at least one workpiece to be processed or machined using at least one single-axis or multiple-axis handling apparatus.

In another embodiment of the method, at least one measurement signal or the force and/or moment measured values recorded in at least one direction is/are output and/or forwarded as absolute values.

The method may advantageously have provision for the motion trajectory of the handling apparatus to be optimized in an application-specific manner between two freely prescribable positions on the basis of the measurement signal or the recorded measured values.

In a further form of the method, the result of the measurement or the evaluation and/or interpretation of the measured values bring about a flexible change in the motion sequence or the process sequence and/or the underlying program.

It is advantageously also possible to provide for single-dimensional or multi-dimensional variables and/or measured values and/or correction values to be ascertained.

Advantageously, the method can be used universally and/or largely independently of the type and/or form and/or nature of the respective workpiece and/or of the respective tool.

### BRIEF DESCRIPTION OF THE DRAWINGS

The invention and advantageous embodiments are illustrated further with reference to a FIGURE and exemplary embodiments.

FIG. 1 shows an example system design for the automated machining and/or processing of workpieces.

### DETAILED DESCRIPTION

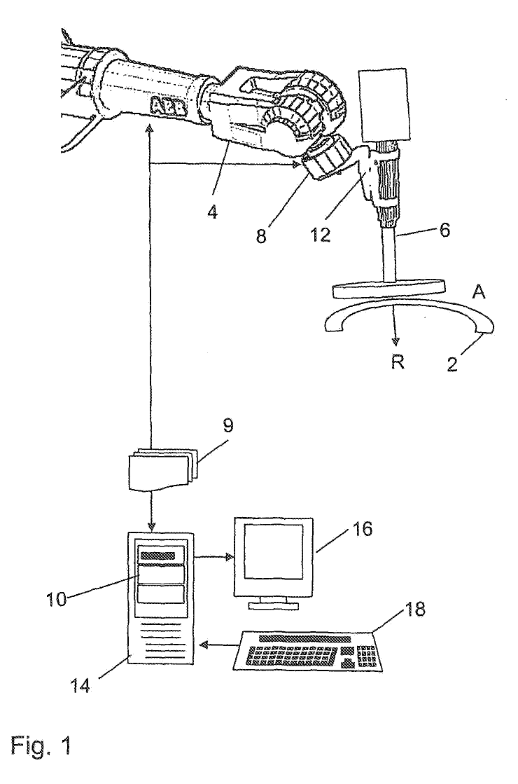

FIG. 1 shows an example system design for the automated machining and/or processing of workpieces. The handling apparatus 4 provided is a multiple-axis robot or industrial robot, particular a six-axis robot, having at least one measuring arrangement 8 with at least one force sensor for recording at least one controlled variable 9.

The distal end of the robot 4 is provided with a holding apparatus 12 for holding at least one tool 6, in the example shown here a grinder or a grinding machine 6. For example, the holding apparatus 12 may have a flange and/or gripper and/or changing magazine for tools.

In principle, however, it is also possible to use further processing tools, such as particularly a polishing and/or milling and/or deburring tool and/or welders.

In addition, a regulatory device 10 is provided which interacts with the measuring arrangement 8 and takes account of the at least one controlled variable 9 to optimize the respective machining and/or processing process by performing and/or prompting controlled-variable-dependent correction of a prescribed motion sequence and hence trajectory and/or position correction of the robot 4 or of the tool 6 relative to the workpiece 2.

An example cited for a workpiece 2 is a housing element, particularly a camera housing part, which needs polishing. The housing elements may be formed from magnesium or aluminum or plastic or a combination thereof, for example.

The measuring arrangement 8 for determining forces and/or moments and/or for determining force and/or moment differences records the bearing force and/or contact force acting in at least one predeterminable direction R between the tool 6 used and the respective workpiece 2 as a controlled variable 9.

In addition, a control device 14 having a display 16 and input device 18 is provided for the purpose of position and/or motion control for the robot 4 and interacts with the regulatory device 10 such that the control device 14 is sent control correction values, particularly motion and/or position correction values, for a prescribed motion sequence and/or trajectory profile which correspond to respectively performed position and/or trajectory optimization and are implemented automatically by said control device. In this case, these correction values are proportioned such that a discrepancy between the respectively recorded controlled-variable measured value and a predeterminable reference value is compensated for, that is to say that the respective controlled variable is regulated to a predeterminable reference value.

In this case, it is possible to take parameters, particularly to take the position of the tool and/or the respective material nature of the workpiece and/or the respective machining step and/or the additives used, for example various grinding and/or polishing pastes, as a basis for using several different or differing reference values too.

Advantageously, it is therefore also possible to perform different machining steps and/or phases.

On the basis of the high level of automation and the regulation of the bearing force between the tool and the workpiece, a comparatively high level of machining and/or process quality, particularly grinding and/or polishing quality, for the system and for the method is reproducibly provided and achieved.

1-48. (canceled)

49. A system for automated processing of workpieces comprising:
at least one handling apparatus having at least one measuring arrangement configured to record at least one controlled variable; and
at least one regulatory device configured to interact with the at least one measuring arrangement to optimize the processing using the at least one controlled variable.

50. The system as recited in claim 49, wherein the processing includes machining.

51. The system as recited in claim 49, wherein the at least one handling apparatus includes a robot.

52. The system as recited in claim 49, wherein the at least one regulatory device is configured to optimize the processing by correcting a prescribed motion sequence including at least one of a trajectory and a position of the handling apparatus.

53. The system as recited in claim 49, wherein the handling apparatus includes a distal end configured to hold at least one of a tool and a workpiece.

54. The system as recited in claim 52, wherein the at least one measuring arrangement is configured to determine at least one of a force, a moment, a force difference, and a moment difference, wherein the at least one controlled variable includes the force, and/or the moment, acting in at least on predeterminable direction relative to the tool and/or workpiece.

55. The system as recited in claim 54, wherein the forces are at least one of bearing forces and contact forces.

56. The system as recited in claim 52, further comprising at least One control device configured to interact with the regulatory device and is capable of receiving correction values corresponding to the corrected prescribed motion sequence so as to implement the prescribed motion sequence.

57. The system as recited in claim 56, further comprising a communication interface configured to provide wired or wireless communication and data interchange between at least one of the regulatory device, the measuring arrangement, and the control device.

58. The system as recited in claim 56, wherein the at least one regulatory device interacts with the at least one control device and the at least one measuring arrangement so as to regulate the force.

59. A method for automated processing of workpieces comprising:
recording at least one controlled variable using at least one measuring arrangement of a handling apparatus; and
optimizing the processing using the at least one controlled variable.

60. The method as recited in claim 59, wherein the optimizing includes correcting a prescribed, motion sequence using the at least one control variable by correction at least one of a trajectory and a position of the handling apparatus.

61. The method as recited in claim 59, further comprising determining at least one of a force, a moment, a force difference, and a moment difference using at least one measuring arrangement, wherein the controlled variable used includes the force and/or moment acting in at least on predeterminable direction relative to at least one of a tool and a workpiece.

62. The method as recited in claim 61, further comprising ascertaining control correction values using recorded controlled variable measured values, transmitting the control correction values to a control device of the handling apparatus, performing position or trajectory optimization, and implementing the position or trajectory optimization.

63. The method as recited in claim 59, wherein the recording includes qualitatively recording at least one of a force and a moment acting in at least one freely prescribable direction or along at least one axis relative to at least one of the tool and the workpiece.

64. The method as recited in claim 62, further comprising transmitting the recorded controlled measured values to the regulatory device.

65. The method as recited in claim 63, further comprising regulating the force and/or moment.

66. The method as recited in claim 59, further comprising providing parameters and selecting a suitable reference value from a predeterminable set of reference values, wherein the optimizing is performed based on the reference value.

67. The method as recited in claim 66, wherein the parameters include at least one of a position of the at least one tool, a material nature of the workpiece, a type of the processing, and at least one additive used.

68. The method as recited in claim 59, further comprising using six possible degrees of rotational freedom of the handling apparatus.

69. The method as recited in claim 59, wherein the at least one measuring arrangement uses at least one of a piezoelectric sensor, a force transducer, and a differential pressure gauge to measure the force or moment.

70. The method as recited in claim 59, further comprising taking into account at. least one of a complex shaping, a material, and a material transition of the workpiece.

71. The method as recited in claim 59, further comprising recording at least one of a physical variable and a process-related variable.

72. The method as recited in claim 59, further comprising using an additive.

73. The method as recited in claim 62, further comprising selecting a type of trajectory optimization under program control using at least one predeterminable characteristic Or at least one further parameter.

74. The method as recited in claim 61, further comprising taking one or more prescribable parameters as a basis to select a respectively suitable reference value from a predeterminable set of reference values.

75. The method as recited in claim 73, wherein the one or more prescribable parameters include at least one of a current position of at least one of the tool and the workpiece, a type of tool used, and a type of the processing.
